(19) United States
(12) Patent Application Publication
(10) Pub. No.: US 2008/0048004 A1
(43) Pub. Date: Feb. 28, 2008

(54) Resonator, ultrasonic head, and ultrasonic bonder using the same

(75) Inventors: Yukio Ozaki, Kawasaki (JP); Toshinori Kasuga, Kawasaki (JP)

Correspondence Address: ARENT FOX LLP, 1050 CONNECTICUT AVENUE, N.W., SUITE 400, WASHINGTON, DC, 20036, US

(73) Assignee: Fujitsu Limited

(21) Appl. No.: 11/907,554

(22) Filed: Oct. 15, 2007

Related U.S. Application Data
(62) Division of application No. 11/077,366, filed on Mar. 11, 2005.

(30) Foreign Application Priority Data
Nov. 30, 2004 (JP) JP2004-345948

(51) Int. Cl. B23K 1/06

(52) U.S. Cl. 228/1.1

(57) ABSTRACT

A resonator 15 includes: a main shaft 12 that is coupled to an ultrasonic vibrator 11 and extends in an advancement direction of an ultrasonic wave generated from the ultrasonic vibrator 11; and protrusions 13a and 13b protruding in a direction intersecting a longitudinal direction from a center plane Lc in the longitudinal direction of the main shaft 11, wherein a plurality of holes 41a, 41b are formed symmetrically with respect to a central plane Lc in the longitudinal direction of the main shaft 12, inside a section substantially orthogonal to a protruding direction of the protrusions 13a and 13b in the vicinity of the center in the longitudinal direction of the main shaft 12 from which the protrusions 13a, 13b protrude.

### CROSS REFERENCE TO RELATED APPLICATION

This Application is a Divisional, which claims the benefit of pending U.S. patent application Ser. No. 11/077,366 filed, Mar. 11, 2005, which also claims the benefit of Japanese patent application number JP 2004-345948, filed Nov. 30, 2004. The disclosures of the prior applications are hereby incorporated herein in their entirety by reference.

### BACKGROUND OF THE INVENTION

The present invention relates to an ultrasonic head for bonding two objects by using ultrasonic vibration, and an ultrasonic bonder using the ultrasonic head.

In recent years, when an LSI chip of many pins is bonded on a substrate, an ultrasonic bonder comes to be used. The basic configuration of the ultrasonic bonder is as shown in FIG. 1. In this ultrasonic bonder, a flip chip bonding method is used to bond the LSI chip onto the substrate.

In FIG. 1, in a state where a bump 22 formed on each of electrode terminals 21 of an LSI chip 20 contacts with a pad 31 formed on a substrate 30, an under-fill 35 fills a space between the LSI chip 20 and the substrate 30. In the ultrasonic bonder, adjustment is performed such that an ultrasonic head 10 is pressed onto a surface of LSI chip 20, opposite to a surface on which electrode terminals 21 are formed. In this state, when the ultrasonic head 10 is vibrated at an ultrasonic frequency (for example, 40 kHz) in a parallel direction (refer to an arrow shown in FIG. 1) to its contact surface with respect to the LSI chip 20, this ultrasonic vibration causes the bump 22 and the pad 31 of the substrate 30 to be rubbed against each other, and their contact surfaces are smoothed and integrated (solid-phase-coupled). Accordingly, each bump 22 of the LSI chip 20 is bonded to the pad 31 on the substrate 30, and the electric connection between the LSI chip 20 and the substrate 30 is attained with reliability.

The ultrasonic head 10 used in the ultrasonic bonder is configured, for example, as shown in FIG. 2. That is, the ultrasonic head 10 has an ultrasonic vibrator 11 and a resonator 15 coupled thereto. The resonator 15 is structured to have a main shaft 12 extending in an advancement direction of an ultrasonic wave generated from the ultrasonic vibrator 11 and protrusions 13a and 13b protruding from a center of a longitudinal direction of the main shaft 12 to a direction vertical to the longitudinal direction of the main shaft. The ultrasonic head 10 is pressed against an object (for example, the LSI chip 20) to be a bonding target with one protrusion 13a contacting with the object. Then, the ultrasonic vibration (longitudinal wave) generated from the ultrasonic vibrator 11 is resonated in the resonator 15, and the ultrasonic vibration of the main shaft 12 at a resonation state is given to the object to be the bonding target from the protrusion 13a.

Specific ultrasonic bonders for bonding the two objects (each bump 22 of the LSI chip 20 and each pad 31 of the substrate 30) as mentioned above have been variously proposed (For example, Patent document 1 and Patent document 2) up to now. The first conventional apparatus (refer to Patent document 1) is structured such that a phase of an expansion contraction variation in a vertical direction of a horn (corresponding to the main shaft in FIG. 2) caused by a longitudinal vibration given by a vibrator is the same phase as a phase of a bending vibration induced in a convex portion (corresponding to the protrusion 13a in FIG. 2). Accordingly, the displacement in the expansion contraction vibration at a side end of a bonding action portion to the object located at the lead of the convex portion is canceled out by the deflection displacement caused by the bending vibration so that the displacement in the vertical lower direction of the bonding action portion in contact with the object can be minimized.

[Patent document 1] JP 2003□218164 A

[Patent document 2] JP 2004□165523 A

### SUMMARY OF THE INVENTION

Note that, in the ultrasonic bonder as mentioned above, a bonding energy E given to the object (for example, the LSI chip 20) to be the bonding target from the ultrasonic head 10 can be represented by an integration value based on the following definition.
∫μPvdt@(·@v=2πfξ) [Equation 1]

μ: friction coefficient

P: pressing force

v: vibration speed

(relative speed between bump 22 and wiring pad 31)

f: oscillation frequency

ξ□ vibration amplitude

In the LSI chip 20 in recent years, in association with the higher integration, the interval between the respective electrode terminals 21 is made narrower (made into a finer pitch), and the smaller size of the bump 22 formed at each electrode terminal 21 is sought. In such a situation, in association with the narrower interval between the respective electrode terminals 21, the vibration amplitude ξ of the ultrasonic head 10 tends to be reduced. Also, in association with the smaller size of the bump 22, a pressing force P tends to be reduced. For this reason, in order to reserve the bonding energy E necessary for the bonding (refer to Equation. 1), it is necessary to increase a frequency of the ultrasonic wave used for the bonding.

In this way, when the oscillation frequency at the ultrasonic head 10 becomes higher, the protrusion 13a of the resonator 15 becomes relatively larger with respect to its wavelength, and the ultrasonic vibration increases the bending vibration amount of the protrusion 13a. FIG. 3 shows a vibration waveform at a predetermined oscillation frequency in the resonator 15 in which an entire length is substantially one wavelength of the ultrasonic wave (about a half wavelength to both sides from a central line). In this case, a standing wave in which an anti-node of the vibration (the maximum amplitude) is located at a center (Disp=0) of the resonator 15 (main shaft 12) and both ends (Disp=λ/2, Disp=−λ/2□ is generated. As shown in FIG. 4, as a length Lₜₒₒₗ in the longitudinal direction of the main shaft 12 (resonator 15) of the protrusion 13a (tool portion) formed in the center of the main shaft 12 becomes larger, the amplitude difference between both sides of the longitudinal direction of the protrusion 13a becomes greater. Moreover, as shown in FIG. 4, since the protrusion 13a protrudes from a longitudinal direction side surface of the main shaft 12, the bending vibration (refer to a two-way arrow) of the protrusion 13a becomes great. Note that the protrusion 13b that does not contact with the object has the same shape as the protrusion 13a, and is similarly operated.

In this way, as the bending vibration amount of the protrusion 13a to be brought into contact with the object to be the bonding target is greater, the contact between the object and the protrusion 13a becomes less stable, which disables the ultrasonic vibration to be efficiently transmitted to the object. In view of the above, the proper length Lₜₒₒₗ of the protrusion (tool portion) 13a in which the amplitude difference is, for example, within 10% is changed, for example, as shown in FIG. 5, in accordance with the oscillation frequency. In FIG. 5, the solid line shows the length Lₜₒₒₗ of the protrusion 13a in which the amplitude difference is 10%, correspondingly to the oscillation frequency. In this case, when the oscillation frequency is 50 kHz, the length Lₜₒₒₗ of the protrusion 13a is about 14 mm, and when the oscillation frequency is 200 kHz, the length Lₜₒₒₗ of the protrusion 13a is about 3 mm (which corresponds to the length indicated by a two-way arrow in FIG. 3). Also, a dot broken line indicates the length Lₜₒₒₗ of the protrusion 13a in which the amplitude difference is 5%, correspondingly to the oscillation frequency. In this case, when the oscillation frequency is 50 kHz, the length Lₜₒₒₗ of the protrusion 13a is about 10 mm, and when the oscillation frequency is 200 kHz, the length Lₜₒₒₗ of the protrusion 13a is about 2 mm.

In this way, in order to increase the oscillation frequency at the ultrasonic head 10, the length (area) of the protrusion (protrusion) 13a to be brought into contact with the object must be reduced. However, when the length Lₜₒₒₗ of the protrusion 13a is thus reduced, the contact area with the object to be the bonding target is reduced, which becomes unsuitable for the bonding to a large object (LSI chip).

The present invention has been made in view of such circumstances. Therefore, an object of the present invention is to provide an ultrasonic head which can suppress a bending vibration of a protrusion without reducing a length (area) of the protrusion in contact with an object that is a bonding target, and an ultrasonic bonder using the ultrasonic head.

A resonator according to the present invention includes: a main shaft that is coupled to an ultrasonic vibrator and extends in an advancement direction of an ultrasonic wave generated from the ultrasonic vibrator; and a protrusion protruding in a direction intersecting a longitudinal direction of the main shaft from a vicinity of a center in the longitudinal direction of the main shaft, in which in the main shaft, a plurality of holes are formed inside a section substantially orthogonal to a protruding direction of the protrusion in the vicinity of the center in the longitudinal direction from which the protrusion protrudes.

In the ultrasonic head of such a configuration, the ultrasonic wave generated from an ultrasonic vibrator is advanced through a main shaft and resonated in a resonator, and a standing wave is generated such that an anti-node is located between the center of the main shaft and both ends in the longitudinal direction of the main shaft inside the resonator. On the other hand, a node of this standing wave is usually generated in the middle between the center and both ends in the longitudinal direction of the main shaft. If this vibration becomes the longitudinal wave vibrating in the advancement direction of the wave from the vibrator, at a particular timing, for example, the center is displaced in the advancement direction, and both the ends in the longitudinal direction are displaced oppositely to the advancement direction. As a result, the portion of the main shaft from the vibrator side end to the center is long in length and thin in section. On the other hand, the portion of the main shaft from the center to the end opposite to the vibrator side is short in length and thick in section. At this time, the protrusion is fallen (bent) and deformed by the forced vibration.

However, in the present invention, in the main shaft, due to each hole formed in the section substantially orthogonal to the protruding direction of the protrusion in the vicinity of the center in the longitudinal direction from which the protrusion protrudes, the rigidity in the vicinity of the protrusion in the main shaft is reduced. Thus, in the vicinity of the main shaft, as compared with the case in which the holes do not exist, the degree where it becomes thick is further increased, and the degree where it becomes thin is further emphasized and thinner. For this reason, the thickening force in the vicinity in the main shaft is applied to the side to which the protrusion is fallen down, and the falling of the protrusion is accordingly suppressed. Also, the pulling force, which tries to further thin as compared with the case that the holes do not exist, is applied to the portion opposite to the side to which the protrusion is fallen down, and the falling of the protrusion is suppressed.

In the resonator according to the present invention, among the plurality of formed holes, the hole formed in a position facing at least the protrusion has a shape that the inner plane of the position facing the protrusion gradually approaches the protrusion toward a central plane which substantially halves the main shaft in the longitudinal direction, from both end sides in the longitudinal direction of the main shaft.

Due to such a configuration, each hole in the vicinity of the protrusion in the main shaft is shaped such that the inner surface facing the protrusion gradually approaches the central surface of the main shaft. As a result, each hole causes the advancement path of the ultrasonic wave to be horned and arrive at the protrusion. For this reason, the vibration amplitude of the ultrasonic vibration at the protrusion can be amplified. That is, in such a configuration, as the vibration is advanced from the main shaft to the protrusion, the section area of the advancement path becomes gradually small. Thus, as compared with the main shaft, the displacement amount of the protrusion, namely, the amplitude becomes great.

Moreover, the resonator according to the present invention further includes a slant that stands up from the main shaft toward the protrusion.

In such a configuration, in the vicinity of the protrusion in the main shaft, the protrusion does not sharply stand up from the main shaft, and the protrusion stands up in succession from a slant. Thus, the ultrasonic vibration advanced through the main shaft is smoothly introduced to the protrusion.

Also, the resonator according to the present invention is configured such that a plurality of holes arrayed in the longitudinal direction of the main shaft are formed in the protrusion.

In such a configuration, the undulation of the end surface of the protrusion in contact with the object to be the bonding target can be made finer by the formed respective holes. Accordingly, it is possible to make the end surface of the protrusion flatter at the time of the vibration.

Also, the ultrasonic head according to the present invention is configured such that the ultrasonic vibrator is coupled to any of the resonators. Moreover, the ultrasonic bonder according to the present invention is configured so as to have the ultrasonic head, include the pressing mechanism for pressing the end surface of the protrusion of the ultrasonic head in at least one of the two objects to be bonded, and give the ultrasonic vibration to the object.

In such a configuration, the stable contact between the object and the protrusion of the resonator in the ultrasonic head is maintained, and the ultrasonic vibration can be efficiently transmitted to the object.

According to the present invention, the thickening force of the vicinity in the main shaft is applied to the side to which the protrusion in the resonator falls down, and the fall of the protrusion is suppressed. Also, the thinning force of the vicinity in the main shaft is applied to the side opposite to the side to which the protrusion falls down.

Moreover, according to the present invention, the undulations of the end surface of the protrusion in contact with the object to be the bonding target are divided into combination of fine undulations by the plurality of holes arrayed in the longitudinal direction of the main shaft formed in the protrusion. Consequently, it is possible to make the end surface of the protrusion flatter.

### BRIEF DESCRIPTION OF THE DRAWINGS

FIG. 1 is a diagram showing a principle of an ultrasonic bonder,

FIG. 2 is a diagram showing a basic structure of an ultrasonic head,

FIG. 3 is a diagram showing a state of a vibration amplitude in a resonator of the ultrasonic head,

FIG. 4 is a diagram showing a bending vibration of a protrusion of the resonator in the ultrasonic head,

FIG. 5 is a diagram showing a relation between an oscillation frequency and a length of a proper protrusion (tool section),

FIG. 6 is a diagram showing the ultrasonic bonder according to an embodiment of the present invention,

FIG. 7 is a diagram showing the structure of an ultrasonic head according to the first embodiment of the present invention,

FIG. 8 is a diagram showing the structure of an ultrasonic head according to a second embodiment of the present invention,

FIG. 9 is a diagram showing the structure of an ultrasonic head according to a third embodiment of the present invention,

FIG. 10 is a diagram showing the structure of an ultrasonic head according to a fourth embodiment of the present invention,

FIG. 11 is a diagram showing the structure of an ultrasonic head according to a fifth embodiment of the present invention,

FIG. 12 is a diagram showing the structure of an ultrasonic head according to a sixth embodiment of the present invention,

FIG. 13 is a diagram showing the structure of an ultrasonic head according to a seventh embodiment of the present invention,

FIG. 14 is a diagram showing the structure of an ultrasonic head according to a eighth embodiment of the present invention,

FIG. 15 is a diagram showing the structure of an ultrasonic head according to a ninth embodiment of the present invention,

FIG. 16 is a diagram showing the structure of an ultrasonic head according to a tenth embodiment of the present invention,

FIG. 17 is a perspective view showing a simulation result (No. 1) of motions of a main shaft and protrusion in the resonator,

FIG. 18 is a front view showing the simulation result (No. 1) of the motions of the main shaft and protrusion in the resonator,

FIG. 19 is a perspective view showing a simulation result (No. 2) of motions of the main shaft and protrusion in the resonator,

FIG. 20 is a front view showing a simulation result (No. 2) of the motions of the main shaft and protrusion in the resonator,

FIG. 21 is a perspective view showing a simulation result (No. 3) of motions of the main shaft and protrusion in the resonator,

FIG. 22 is a front view showing the simulation result (No. 3) of the motions of the main shaft and protrusion in the resonator,

FIG. 23 is a perspective view showing a simulation result (No. 4) of motions of the main shaft and protrusion in the resonator,

FIG. 24 is a front view showing the simulation result (No. 4) of the motions of the main shaft and protrusion in the resonator.

### DETAILED DESCRIPTION OF THE INVENTION

Embodiments of the present invention will be described below with reference to the drawings.

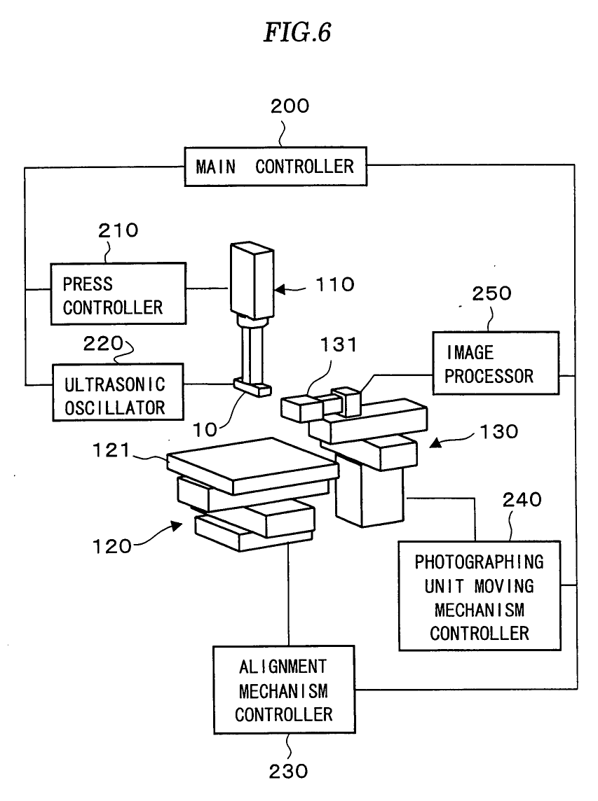

An ultrasonic bonder according to a first embodiment of the present invention is structured as shown in FIG. 6.

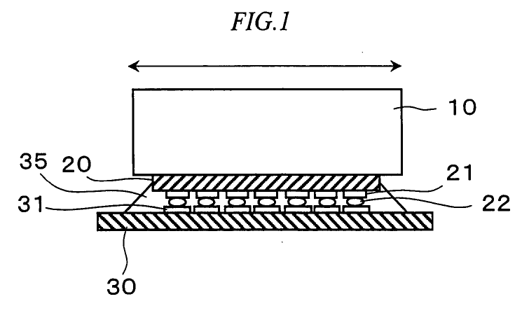

In FIG. 6, this ultrasonic bonding is performed, for example, as shown in FIG. 1. This ultrasonic bonder has a pressing mechanism 110, an alignment mechanism 120, a stage 121, a photographing unit moving mechanism 130, and a photographing unit 131. An ultrasonic head 10 is mounted at a tip of the pressing mechanism 110, and the pressing mechanism 110 (corresponds to a pressing mechanism of the present invention) lifts up and down the ultrasonic head 10 in a vertical direction (in a Z-axis direction). The stage 121 is fixed to an upper end of the alignment mechanism 120, and the alignment mechanism 120 moves the stage 121 inside a horizontal plane (X-Y plane) and moves without inclining with respect to the Z-axis. The photographing unit 131 is fixed to the photographing unit moving mechanism 130 so that a predetermined region above the stage 121 becomes a photograph range. The photographing unit moving mechanism 130 moves the photographing unit 131 inside the horizontal plane (X-Y plane).

The ultrasonic bonder further has a press controller 210, an ultrasonic oscillator 220, a photographing unit moving mechanism controller 240, an image processor 250 and a main controller 200. Under the control of the main controller 200, the ultrasonic oscillator 220 outputs an ultrasonic drive signal of a predetermined frequency to the ultrasonic head 10. One object (for example, a substrate) to be bonded is set on the stage 121. On the other hand, the other object (for example, an LSI chip) to be bonded is adsorbed to and held by the ultrasonic head 10 mounted at the tip of the pressing mechanism 110. The photographing unit 131 can photograph in two directions (stage 121 direction and ultrasonic head 10 direction). The photographing unit 131 photographs the object set on the stage 121 and the object held by the ultrasonic head 10 and outputs an appropriate photograph signal. The image processor 250 performs a predetermined image process on the photograph signal from the photographing unit 131 and outputs a predetermined image signal.

The photographing unit moving mechanism controller 240 carries out a drive control of the photographing unit moving mechanism 130 so that the photographing unit 131 has a predetermined position relation to the object set on the stage 121, under the control of the main controller 200. The press controller 210 carries out the drive control of the pressing mechanism 110 on which the ultrasonic head 10 is mounted, under the control of the main controller 200. The alignment mechanism controller 230 carries out the drive control (positioning) of the alignment mechanism 120 so that the other object, which is mounted at the tip of the ultrasonic head 10 and becomes the bonding target, contacts with one object, which is set on the stage 121 and becomes the bonding target, at a predetermined position relation without any inclination, under the control of the main controller 200 based on an image signal from the image processor 250. Then, the pressing mechanism 110 drive-controlled by the press controller 210 presses the object mounted at the ultrasonic head 10 against the object set on the stage 121 at a predetermined pressure. In this situation, the ultrasonic oscillator 220 supplies an ultrasonic signal to the ultrasonic head 10, and the ultrasonic head 10 is ultrasonically vibrated, and the two objects are bonded by the ultrasonic vibration of the ultrasonic head 10.

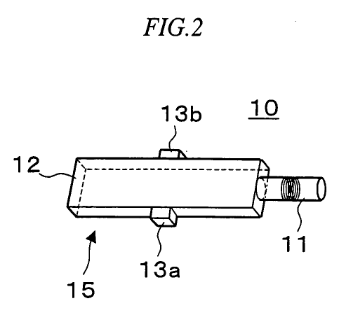

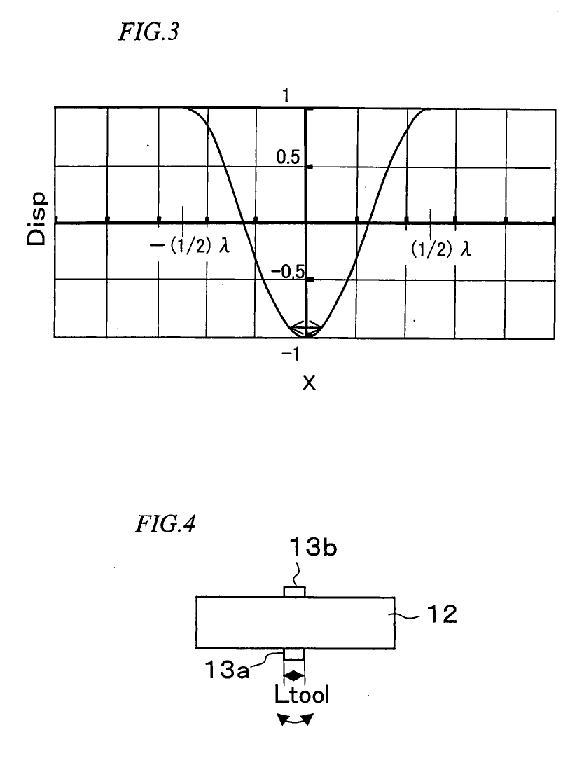

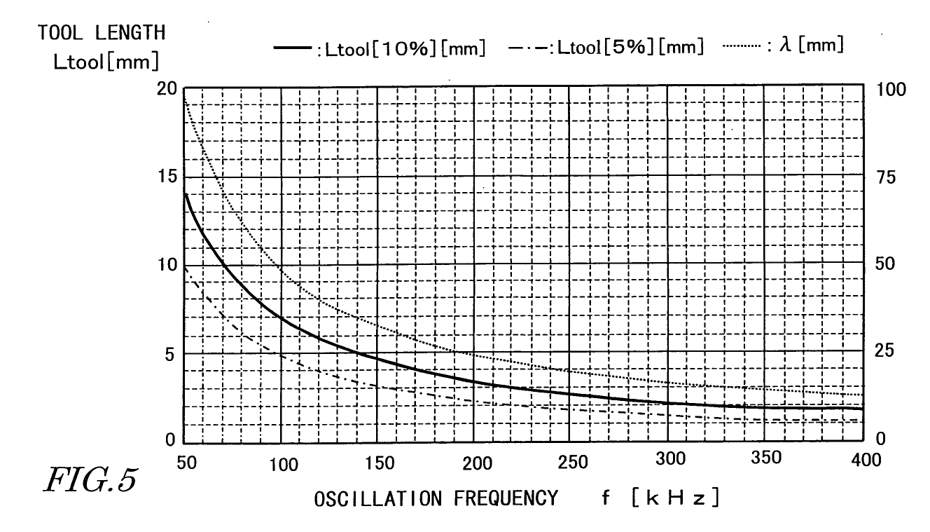

The ultrasonic head 10 mounted at the tip of the pressing mechanism 110 basically includes the ultrasonic vibrator 11 and the resonator 15 coupled thereto, similarly to those shown in FIG. 2. The resonator 15 is structured so as to have the main shaft 12 extending in the advancement direction of the ultrasonic wave generated from the ultrasonic vibrator 11 and the protrusions 13a, 13b protruding from the center of the longitudinal direction of the main shaft 12 to the direction vertical to the longitudinal direction.

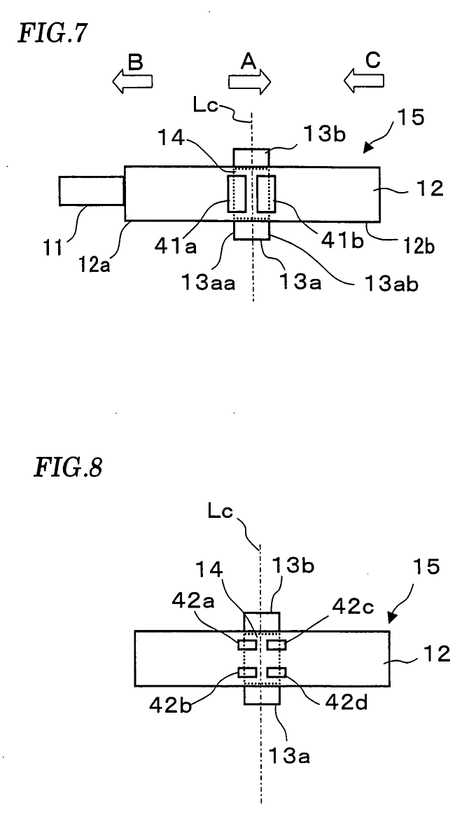

The ultrasonic head 10 according to the first embodiment of the present invention has the structure shown in FIG. 7, in addition to the basic structure shown in FIG. 2. In this ultrasonic head 10, two rectangular holes 41a, 41b are formed approximately symmetrically with respect to a central plane Lc which substantially halves the main shaft 12 in the longitudinal direction.

Those two holes 41a, 41b are formed in the section approximately orthogonal to the protruding direction of the protrusions 13a, 13b in the vicinity of the center in the longitudinal direction of the main shaft 12 from which the protrusions 13a, 13b protrude. The end surface of one protrusion 13a (tool portion) is brought into contact with one object (for example, the LSI chip) to be the bonding target. Note that, an adsorbing mechanism (for example, an opening that sucks air and generates a negative pressure) which is not shown is placed in the protrusion 13a, and the LSI chip and the like can be adsorbed.

In the ultrasonic head 10 of such structure, the ultrasonic vibration generated from the ultrasonic vibrator 11 is advanced through the main shaft 12 and resonated in the resonator 15, and the standing wave is generated such that the anti-nodes are located at the center of the main shaft 12 inside the resonator 15 and both ends thereof.

On the other hand, the node of this standing wave is usually generated in the middle between the center plane Lc and both ends in the longitudinal direction of the main shaft 12. If this vibration becomes the longitudinal wave vibrating in the advancement direction of the wave from the vibrator 11, at the particular timing, for example, the center of the main shaft 12 is displaced in the advancement direction (the A arrow direction of FIG. 7), and both the ends in the longitudinal direction of the main shaft 12 are displaced oppositely to the advancement direction (the B-arrow and C-arrow in FIG. 7). As a result, a portion 12a of the main shaft 12 from the end of the vibrator 11 side to the center is long in length and thin in section. On the other hand, a portion 12b of the main shaft from the center to the end opposite to the vibrator 11 side is short in length and thick in section.

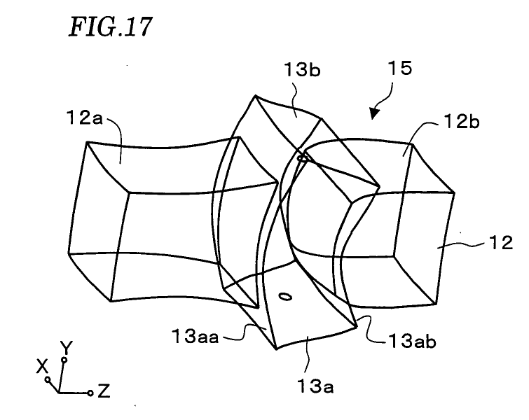

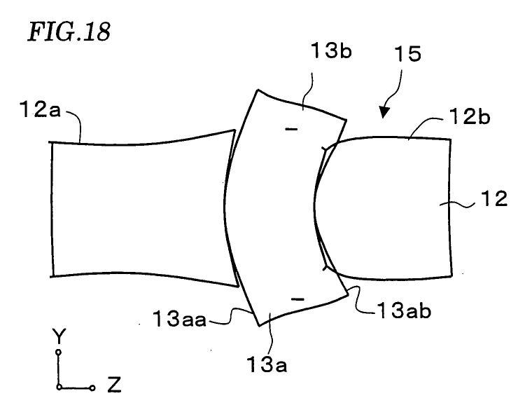

Also, at this timing, the protrusions 13a, 13b protruding from the vicinity of the center in the longitudinal direction of the main shaft have the greater displacements than the main shaft 12. Thus, the tips of the protrusions 13a, 13b are further displaced in the advancement direction than the center of the main shaft, and the protrusions 13a, 13b become at the state fallen down to the advancement direction (refer to the simulation results of FIG. 17 and FIG. 18).

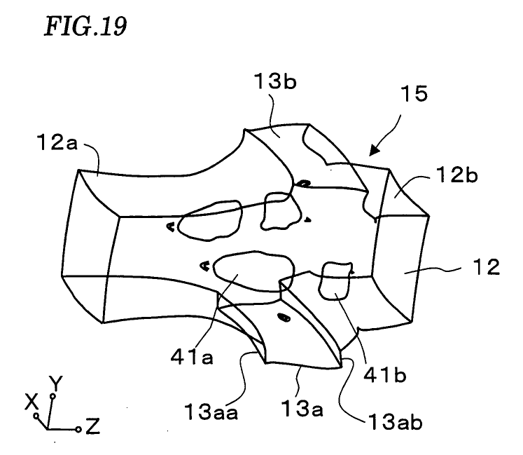

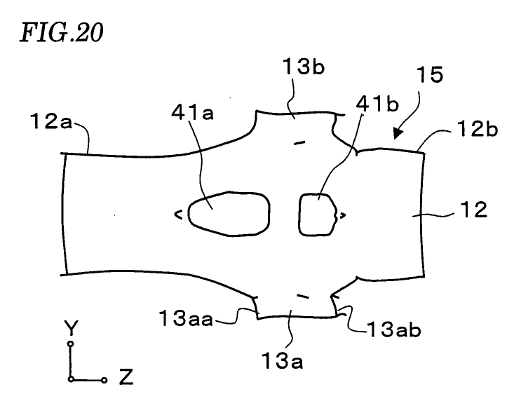

In such situation, the rigidities in the portions on which the holes 41a, 41b of the main shaft 12 are formed are reduced. Thus, in the vicinity of the protrusion 13a of the main shaft 12, the degree where it becomes thick is further increased, and the degree where it becomes thin is further emphasized and thinned. For this reason, the relatively great thickening force of the vicinity in the main shaft 12 is applied to the side 13ab to which the protrusion 13a is fallen down, and the falling of one side 13ab of the protrusion 13a is accordingly suppressed. Also, the relatively great thinning force of the vicinity in the main shaft 12 is applied as the pulling force to the opposite side 13aa to the side 13ab to which the protrusion 13a is fallen down, and the extension of the other side 13aa of the protrusion 13a is suppressed. As a result, the falling of the protrusion 13a is reduced. Such operation is similar even in the protrusion 13b (refer to the simulation results of FIG. 19 and FIG. 20).

Due to the motions of the main shaft 12 and protrusion 13a (13b) in the resonator 15, the bending vibration of the protrusion 13a is suppressed, which enables the end surface of the protrusion 13a to be brought into stable contact with the object to be the bonding target. The simulation results of the motions of the main shaft 12 and protrusion 13a (13b) in the resonator 15 are shown in FIG. 17 to FIG. 20. FIG. 17 (perspective view) and FIG. 18 (front view) show the resonator 15 in which the hole is not formed in the main shaft 12, and FIG. 19 (perspective view) and FIG. 20 (front view) show the resonator 15 in which the holes 41a, 41b are formed in the main shaft 12. If the hole is not formed in the main shaft 12, as shown in FIG. 17 and FIG. 18, the protrusions 13a, 13b carry out the bending vibration. On the contrary, if the holes 41a, 41b are formed in the main shaft 12, as shown in FIG. 19 and FIG. 20, the bending vibrations of the protrusions 13a, 13b are suppressed.

An ultrasonic head 10 according to a second embodiment of the present invention has a structure shown in FIG. 8, in addition to the basic structure shown in FIG. 2. In this ultrasonic head 10, four rectangular holes 42a, 42b, 42c, and 42d are formed symmetrically with respect to a central plane Lc in the longitudinal direction in the main shaft 12. Those four holes 42a, 42b, 42c, and 42d are formed such that a part is located at a protrusion correspondence portion 14 of the main shaft 12.

Even in the ultrasonic head 10 of such structure, the main shaft 12 and the protrusions 13a, 13b are operated similarly to the case of the first embodiment (refer to FIG. 7), and the bending vibrations of the protrusions 13a, 13b are suppressed by the four holes 42a, 42b, 42c, and 42d.

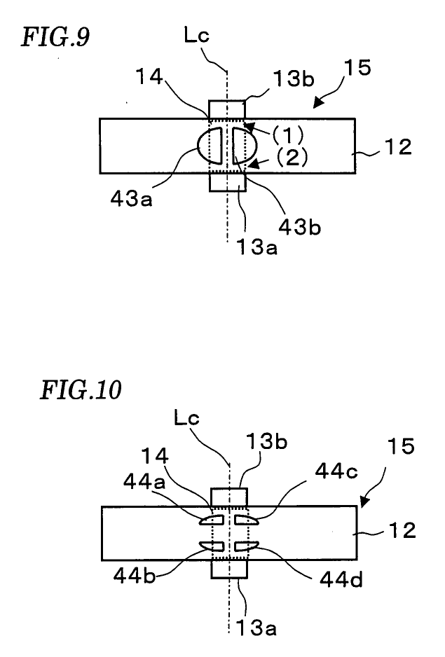

An ultrasonic head 10 according to a third embodiment of the present invention has a structure shown in FIG. 9, in addition to the basic configuration shown in FIG. 2. In this ultrasonic head 10, holes 43a, 43b having the shapes to which a shape close to an ellipse is halved are formed substantially symmetrically with respect to a central plane Lc which substantially halves the main shaft 12 in the longitudinal direction thereof. The holes 43a, 43b to which the shape close to this ellipse is halved have the shapes in which the inner planes at the positions facing the protrusions 13a, 13b gradually approach the protrusions 13a, 13b toward the central plane Lc, which substantially halves the main shaft 12 in the longitudinal direction, from both end sides in the longitudinal direction of the main shaft 12. Those two holes 43a, 43b are formed inside the section substantially orthogonal to the protruding direction of the protrusions 13a, 13b in the vicinity of the center in the longitudinal direction of the main shaft 12 from which the protrusions 13a, 13b protrude.

Even in the ultrasonic head 10 of such structure, the main shaft 12 and the protrusions 13a, 13b act similarly to the case of the first embodiment (refer to FIG. 7), and the two holes 43a, 43b suppress the bending vibrations of the protrusions 13a, 13b. Moreover, each of the holes 43a, 43b has the shape in which the ellipse expanding toward the central plane Lc is halved. Thus, in the vicinities of the protrusions 13a, 13b in the main shaft 12, since the advancement path of the ultrasonic wave (for example, refer to the arrows (1), (2) in FIG. 9) is horned and arrives at the protrusions 13a, 13b, the vibration amplitude of the ultrasonic vibration at the protrusion 13a is amplified. That is, in such a configuration, as the vibration is advanced from the main shaft 12 to the protrusions 13a, 13b, the section area of the advancement path becomes gradually small. Thus, as compared with the main shaft 12, the displacement amounts of the protrusions 13a, 13b, namely, the amplitude becomes large. Accordingly, the ultrasonic vibration can be effectively given to the object to be the bonding target in contact with the protrusion 13a (tool portion).

An ultrasonic head 10 according to a fourth embodiment of the present invention has a structure shown in FIG. 10, in addition to the basic structure shown in FIG. 2. In this ultrasonic head 10, four holes 44a, 44b, 44c, and 44d having the shapes to which the ellipse is quartered are formed substantially symmetrically with respect to the central plane Lc that substantially halves the main shaft 12 in the longitudinal direction thereof. Those four holes 44a, 44b, 44c, and 44d are formed such that a part is located at the protrusion correspondence portion 14 of the main shaft 12. Thus, those holes 44a, 44b, 44c, and 44d have the shapes in which the inner planes at the positions facing the protrusions 13a, 13b gradually approach the protrusions 13a, 13b toward the central plane Lc, which substantially halves the main shaft 12 in the longitudinal direction, from both end sides in the longitudinal direction of the main shaft 12.

Even in the ultrasonic head 10 of such structure, the main shaft 12 and the protrusions 13a, 13b act similarly to the case of the first embodiment (refer to FIG. 7), and the four holes 44a, 44b, 44c, and 44d suppress the bending vibrations of the protrusions 13a, 13b. Also, moreover, similarly to the case of the third embodiment (refer to FIG. 9), in the vicinities of the protrusions 13a, 13b in the main shaft 12, since the advancement path of the ultrasonic wave is horned, the vibration amplitude of the ultrasonic vibration at the protrusion 13a is amplified. Note that, even although a larger number of holes are formed as compared with the case of FIG. 10, if the inner planes have the shapes gradually approaching the protrusions 13a, 13b toward the central plane Lc, which substantially halves the main shaft 12 in the longitudinal direction, from both end sides in the longitudinal direction of the main shaft 12, at least in the holes formed at the positions facing the protrusions 13a, 13b, the same effect is obtained.

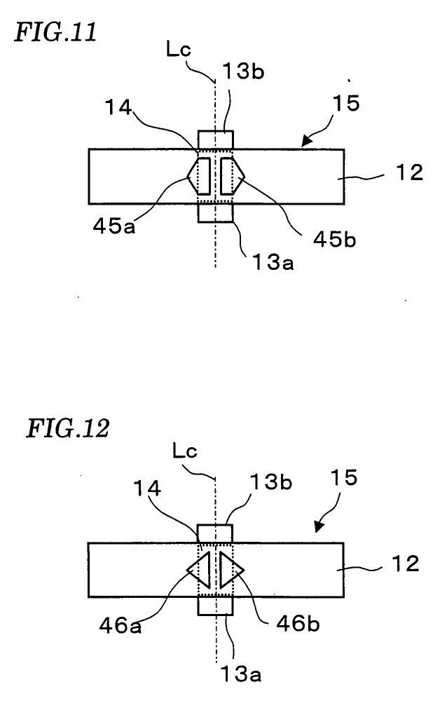

An ultrasonic head 10 according to a fifth embodiment of the present invention has a structure shown in FIG. 11, in addition to the basic structure shown in FIG. 2. In this ultrasonic head 10, pentagonal two holes 45a, 45b are formed substantially symmetrically with respect to the central plane Lc that substantially halves the main shaft 12 in the longitudinal direction thereof. Those two holes 45a, 45b have the portions expanding toward the central plane Lc and are also formed inside the section substantially orthogonal to the protruding directions of the protrusions 13a, 13b in the vicinities of the center in the longitudinal direction of the main shaft 12 from which protrusions 13a, 13b protrude. That is, the section shapes of the holes 45a, 45b formed at the positions facing the protrusions 13a, 13b are the pentagonal shapes which have hypotenuses reclining for the longitudinal direction of the main shaft 12 and gradually approaching the protrusions.

Even in the ultrasonic head 10 of such structure, similarly to the third embodiment (refer to FIG. 9), the suppression effect of the bending vibrations of the protrusions 13a, 13b and the amplification effect of the vibration amplitude of the protrusion 13a (tool portion) are obtained.

An ultrasonic head 10 according to a sixth embodiment of the present invention has a structure shown in FIG. 12, in addition to the basic structure shown in FIG. 2. In this ultrasonic head 10, triangular two holes 46a, 46b are formed substantially symmetrically with respect to the central plane Lc that substantially halves the main shaft 12 in the longitudinal direction thereof. Those two holes 46a, 46b have the shapes expanding toward the central plane Lc and are formed inside the section substantially orthogonal to the protruding directions of the protrusions 13a, 13b in the vicinities of the center in the longitudinal direction of the main shaft 12 from which protrusions 13a, 13b protrude. That is, the section shapes of the holes 46a, 46b are triangular shapes which have hypotenuses reclining for the longitudinal direction of the main shaft 12 and gradually approaching the protrusions 13a, 13b.

Even in the ultrasonic head 10 of such structure, similarly to the third embodiment (refer to FIG. 9) and the fifth embodiment (refer to FIG. 11), the suppression effect of the bending vibrations of the protrusions 13a, 13b and the amplification effect of the vibration amplitude of the protrusion 13a (tool portion) are obtained.

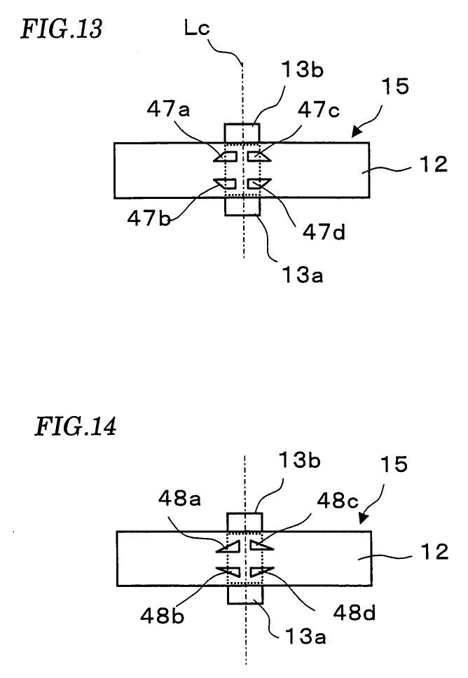

An ultrasonic head 10 according to a seventh embodiment of the present invention has a structure shown in FIG. 13, in addition to the basic structure shown in FIG. 2. In this ultrasonic head 10, pentagonal four holes 47a, 47b, 47c, and 47d are formed substantially symmetrically with respect to the central plane Lc that substantially halves the main shaft 12 in the longitudinal direction thereof. Those four holes 47a, 47b, 47c, and 47d have the shapes expanding toward the central plane Lc and are formed inside the section substantially orthogonal to the protruding directions of the protrusions 13a, 13b in the vicinities of the center in the longitudinal direction of the main shaft 12 from which protrusions 13a, 13b protrude. Also, those four holes 47a, 47b, 47c, and 47d correspond to the holes formed at the positions facing at least the protrusions 13a, 13b. Those holes 47a, 47b, 47c, and 47d have the shapes in which the inner planes of the positions facing the protrusions 13a, 13b gradually approach the protrusions 13a, 13b toward the central plane Lc, which substantially halves the main shaft 12 in the longitudinal direction, from both end sides in the longitudinal direction of the main shaft 12. Note that, the case in which five or more holes are formed (for example, a case in which further other holes are formed between the holes 47a, 47b) is also similar.

Even in the ultrasonic head 10 of such structure, similarly to the fourth embodiment (refer to FIG. 10), the suppression effect of the bending vibrations of the protrusions 13a, 13b and the amplification effect of the vibration amplitude of the protrusion 13a (tool portion) are obtained.

An ultrasonic head 10 according to an eighth embodiment of the present invention has a structure shown in FIG. 14, in addition to the basic structure shown in FIG. 2. In this ultrasonic head 10, triangular four holes 48a, 48b, 48c, and 48d are formed substantially symmetrically with respect to the central plane Lc that substantially halves the main shaft 12 in the longitudinal direction thereof. Those four holes 48a, 48b, 48c, and 48d have the shapes expanding toward the central plane Lc and are formed inside the section substantially orthogonal to the protruding directions of the protrusions 13a, 13b in the vicinities of the center in the longitudinal direction of the main shaft 12 from which protrusions 13a, 13b protrude.

Even in the ultrasonic head 10 of such structure, similarly to the fourth embodiment (refer to FIG. 10) and the seventh embodiment (refer to FIG. 13), the suppression effect of the bending vibrations of the protrusions 13a, 13b and the amplification effect of the vibration amplitude of the protrusion 13a (tool portion) are obtained.

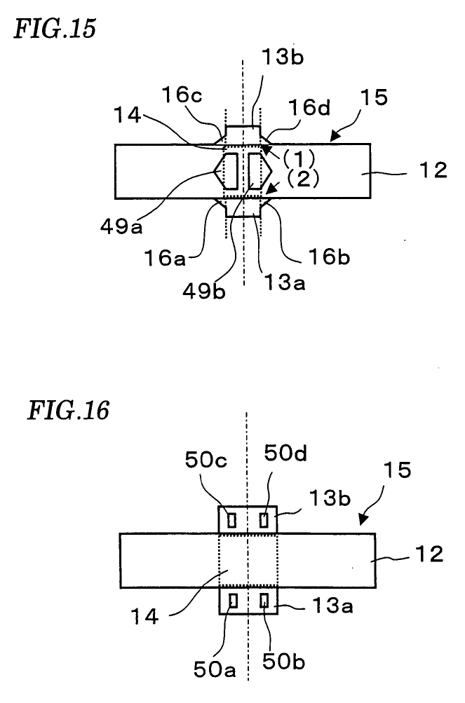

An ultrasonic head 10 according to a ninth embodiment of the present invention has a structure shown in FIG. 15, in addition to the basic structure shown in FIG. 2. In this ultrasonic head 10, similarly to the fifth embodiment shown in FIG. 11, pentagonal two holes 49a, 49b are formed in the main shaft 12, substantially symmetrically with respect to the central plane Lc so that a part thereof is located at the protrusion correspondence portion 14. Moreover, slants 16a, 16b are formed which stand up from the main shaft 12 toward both sides in the longitudinal direction of the protrusion 13a, respectively. Also, slants 16c, 16d are formed which stand up from the main shaft 12 toward both sides in the longitudinal direction of the protrusion 13b, respectively.

In the ultrasonic head 10 of such structure, due to the pentagonal holes 49a, 49b having the portions expanding toward the central plane Lc, similarly to the fifth embodiment (refer to FIG. 11), the suppression effect of the bending vibrations of the protrusions 13a, 13b and the amplification effect of the vibration amplitude of the protrusion 13a (tool portion) are obtained. Moreover, the ultrasonic wave is smoothly introduced to the protrusions 13a, 13b through the advancement path (refer to the arrows (1), (2) in FIG. 15) composed of the portion expanding toward the central lines Lc of the respective holes 49a, 49b of the pentagon and the slants 16a, 16b and 16c, 16d formed for the protrusions 13a, 13b. Accordingly, the further efficient vibration of the protrusion 13a (tool portion) becomes possible.

An ultrasonic head 10 according to a tenth embodiment of the present invention has a structure shown in FIG. 16, in addition to the basic structure shown in FIG. 2. In this ultrasonic head 10, rectangular holes 50a, 50b and 50c, 50d (slit shapes are allowable) are formed in the respective protrusions 13a, 13b symmetrically with respect to the central plane Lc. Note that, similarly to the respective embodiments, the plurality of holes may be formed such that a part thereof is located at the protrusion correspondence portion 14 symmetrically with respect to the central plane Lc.

In the ultrasonic head 10 of such structure, although undulations are induced on the end surfaces of the respective protrusions 13a, 13b at the time of the ultrasonic vibration, the respective holes 50a, 50b and 50c, 50d cause the rigidities in the respective protrusions 13a, 13b to be irregular, which accordingly makes the undulations on the end surfaces of the respective protrusions 13a, 13b finer. That is, the respective holes 50a, 50b and 50c, 50d have the effect of dividing the region where the undulation is induced. The individual regions divided by the respective holes 50a, 50b and 50c, 50d result in the inductions of the respective fine undulations. Thus, the flattening in the vibration time of the end surface of the protrusion 13a (tool portion) in contact with the object to be the bonding target can be attained, which can keep the adherence between the end surface of the protrusion 13a and the object to be the bonding target excellent. As a result, the ultrasonic vibration can be further efficiently given to the object from the protrusion 13a.

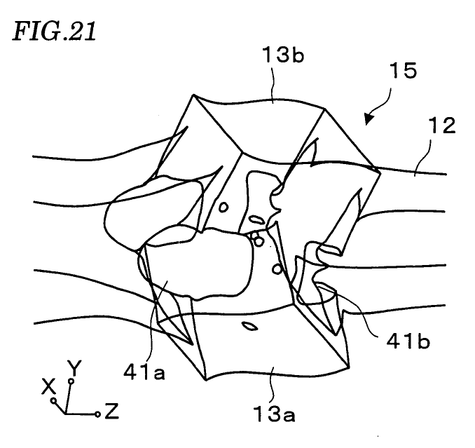

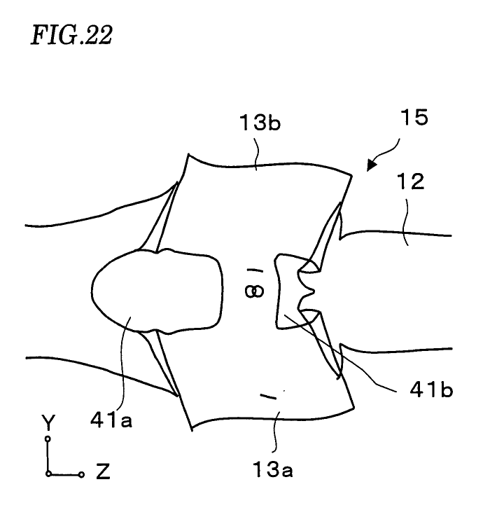

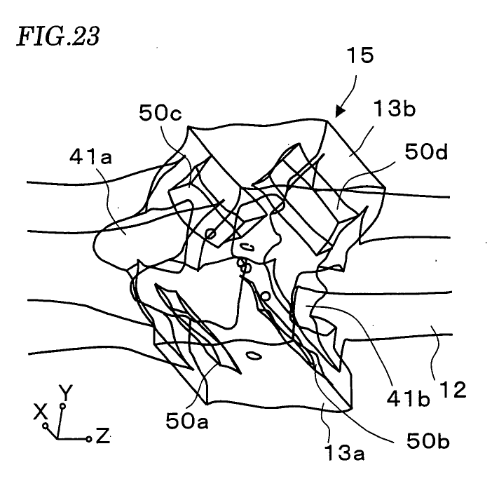

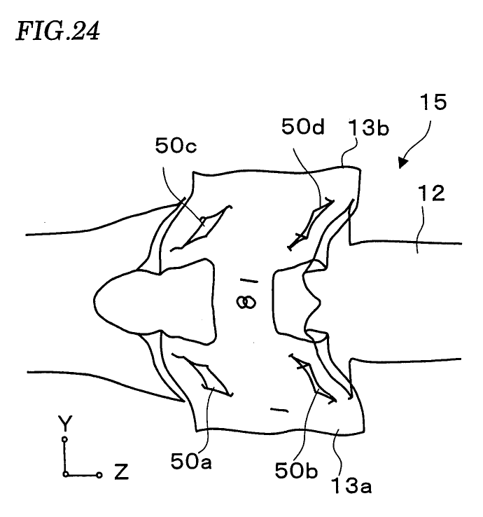

The simulation results of the motions of the main shaft 12 and protrusion 13a (13b) in the resonator 15 are shown in FIG. 21 to FIG. 24. FIG. 21 (perspective view) and FIG. 22 (front view) show the resonator 15 in which the holes are not formed in the protrusions 13a, 13b. FIG. 23 (perspective view) and FIG. 24 (front view) show the resonator 15 in which the holes 50a, 50b and 50c, 50d are formed in the protrusions 13a, 13b. Note that, in the resonator 15 shown in FIG. 21 to FIG. 24, the holes 41a, 41b (refer to FIG. 7) are formed even in the main shaft 12, symmetrically with respect to the central plane Lc.

If the holes are not formed in the respective protrusions 13a, 13b, as shown in FIG. 21 and FIG. 22, the undulations formed on the end surfaces of the respective protrusions 13a, 13b become relatively large. However, if the holes 50a, 50b and 50c, 50d are formed in the respective protrusions 13a, 13b, as shown in FIG. 23 and FIG. 24, the undulations on the end surfaces of the respective protrusions 13a, 13b are finer.

### INDUSTRIAL APPLICABILITY

As described above, the present invention produces the effect that it is possible to suppress the bending vibration of the protrusion without reducing the length (area) of the protrusion in contact with the body which becomes the bonding target, and is useful as the ultrasonic head for bonding two objects by using the ultrasonic vibration, and the ultrasonic bonder using the ultrasonic head.

What is claimed is:

1. A resonator comprising: a main shaft that is coupled to an ultrasonic vibrator and extends in an advancement direction of an ultrasonic wave generated from the ultrasonic vibrator; a protrusion protruding in a direction intersecting a longitudinal direction of the main shaft from a vicinity of a center in the longitudinal direction of the main shaft, and a slant that stands up from the main shaft toward the protrusion;
wherein in the main shaft, a plurality of holes are formed inside a section substantially orthogonal to a protruding direction of the protrusion in the vicinity of the center in the longitudinal direction from which the protrusion protrudes and wherein among the plurality of formed holes, the hole formed in a position facing at least the protrusion has a shape that the inner plane of the position facing the protrusion gradually approaches the protrusion toward a central plane which substantially halves the main shaft in the longitudinal direction, from both end sides in the longitudinal direction of the main shaft.

2. The resonator according to claim 1, wherein among the plurality of formed holes, the hole formed in a position facing at least the protrusion has a shape that the inner plane of the position facing the protrusion gradually approaches the protrusion toward a central plane which substantially halves the main shaft in the longitudinal direction, from both end sides in the longitudinal direction of the main shaft.

3. The resonator according to claim 2, further comprising a slant that stands up from the main shaft toward the protrusion;
ultrasonic wave generated from the ultrasonic vibrator; and
a protrusion protruding in a direction intersecting a longitudinal direction of the main shaft from a vicinity of a center in the longitudinal direction of the main shaft,
wherein a plurality of holes arrayed in the longitudinal direction of the main shaft are formed in the protrusion.
